(19) United States
(12) Patent Application Publication
(10) Pub. No.: US 2024/0198277 A1
(43) Pub. Date: Jun. 20, 2024

(54) DIRECT AIR CAPTURE SYSTEM

(71) Applicant: TOYOTA JIDOSHA KABUSHIKI KAISHA, Toyota-shi (JP)

(72) Inventors: Takahiro Sadamitsu, Miyoshi-shi (JP); Kiyoshi Fujihara, Susono-shi (JP); Shuichi Ikeya, Sunto-gun (JP); Yusuke Hoki, Mishima-shi (JP)

(73) Assignee: TOYOTA JIDOSHA KABUSHIKI KAISHA, Toyota-shi (JP)

(21) Appl. No.: 18/484,479

(22) Filed: Oct. 11, 2023

(30) Foreign Application Priority Data
Dec. 20, 2022 (JP) 2022-203556

(51) Int. Cl. B01D 53/04

(52) U.S. Cl. CPC B01D 53/0446; B01D 2257/504; B01D 2258/06; B01D 2259/402

(57) ABSTRACT

DAC system includes a first direct air capture (DAC) device for recovering carbon dioxide from an atmosphere, a second DAC device in which an intake port is installed to be located at a side of an exhaust port of the first DAC device, and that recovers carbon dioxide from the atmosphere, and a stirring plate disposed between the first DAC device and the second DAC device for stirring the air discharged from the exhaust port of the first DAC device and the atmosphere.

### CROSS-REFERENCE TO RELATED APPLICATION

This application claims priority to Japanese Patent Application No. 2022-203556 filed on Dec. 20, 2022 incorporated herein by reference in its entirety.

### BACKGROUND

### 1. Technical Field

The present disclosure relates to a DAC system.

### 2. Description of Related Art

In recent years, a development of a direct air capture (DAC) device that recovers carbon dioxide from the atmosphere is in progress. “Direct Air Capture of CO₂ with Chemicals”, A Technology Assessment for the APS Panel on Public Affairs, Jun. 1, 2011 describes the recovery of carbon dioxide from the atmosphere using a plurality of DAC devices.

### SUMMARY

However, in the configuration disclosed in “Direct Air Capture of CO₂ with Chemicals”, A Technology Assessment for the APS Panel on Public Affairs, Jun. 1, 2011, as many DAC devices as possible are disposed per predetermined area. Therefore, when a plurality of DAC devices is disposed close to each other, the carbon dioxide-recovered air discharged from a certain DAC device is taken in by another DAC device disposed close to an exhaust port of the certain DAC device. Therefore, a carbon dioxide recovery process is performed for an air with low carbon dioxide density in the another DAC device. As a result, there was a problem that carbon dioxide recovery efficiency by the another DAC device is decreased. Therefore, in the configuration disclosed in “Direct Air Capture of CO₂ with Chemicals”, A Technology Assessment for the APS Panel on Public Affairs, Jun. 1, 2011, the DAC devices needed to be disposed apart.

The present disclosure has been made in view of the above-described background, and an object of the present disclosure is to provide a DAC system in which a plurality of DAC devices can be disposed close to each other while suppressing a decrease in carbon dioxide recovery efficiency by each of the DAC devices.

A direct air capture system according to the present disclosure includes a first direct air capture device that recovers carbon dioxide from an atmosphere, a second direct air capture device in which an intake port is installed to be located at a side of an exhaust port of the first direct air capture device, and that recovers carbon dioxide from an atmosphere, and a stirring plate installed between the first direct air capture device and the second direct air capture device and configured to stir air discharged from the exhaust port of the first direct air capture device and an atmosphere. In the direct air capture system, the decrease in carbon dioxide recovery efficiency by the second direct air capture device adjacent to the first direct air capture device can be suppressed, due to stirring of the carbon dioxide-recovered air discharged from the exhaust port of the first direct air capture device and the atmosphere using the stirring plate. As a result, in the direct air capture system, the first direct air capture device can be disposed close to the second direct air capture device. That is, in the direct air capture system, it is possible to dispose a plurality of direct air capture devices close to each other while suppressing a decrease in carbon dioxide recovery efficiency by each of the direct air capture devices.

According to the present disclosure, it is possible to provide a DAC system in which a plurality of DAC devices can be disposed close to each other while suppressing a decrease in carbon dioxide recovery efficiency by each of the DAC devices.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a first exemplary configuration of a DAC system according to a first embodiment;

FIG. 2 is a diagram illustrating an example of the DAC system according to the first embodiment;

FIG. 3 is a diagram illustrating a second exemplary configuration of the DAC system according to the first embodiment;

FIG. 4 is a diagram illustrating a third exemplary configuration of the DAC system according to the first embodiment; and

FIG. 5 is a diagram illustrating a fourth exemplary configuration of the DAC system according to the first embodiment.

### DETAILED DESCRIPTION OF EMBODIMENTS

Hereinafter, the present disclosure will be described through embodiments of the disclosure, but the disclosure according to the claims is not limited to the following embodiments. Further, not all of the configurations described in the embodiments are essential as means for solving the problem. For clarity of explanation, the following description and the drawings are omitted and simplified as appropriate. In the drawings, the same elements are denoted by the same reference numerals, and redundant descriptions are omitted as necessary.

### Embodiment 1

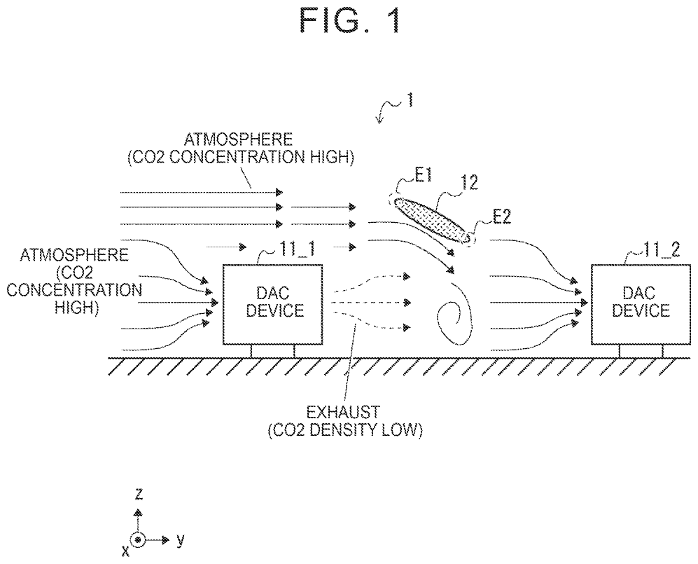

FIG. 1 is a diagram illustrating a first exemplary configuration of a DAC system 1 according to a first embodiment. In the DAC system 1 according to the present embodiment, the carbon dioxide recovered air discharged from the exhaust port of the first DAC device and the atmosphere are agitated by using a stirring plate. By this stirring, it is possible to prevent the reduction of the carbon dioxide recovery rate by the second DAC device adjoining the first DAC device. Therefore, in the DAC system 1 according to the present embodiment, the first DAC device and the second DAC device can be disposed close to each other. That is, in the DAC system 1 according to the present embodiment, the plurality of DAC devices can be disposed close to each other while preventing a decrease in the carbon dioxide recovery rate caused by each of the plurality of DAC devices. Hereinafter, it will be described in detail.

As illustrated in FIG. 1, DAC system 1 includes at least a DAC device 11_1, a DAC device 11_2, and a stirring plate 12. Each of DAC devices 11_1 and 11_2 includes, for example, a porous solid-state absorbent material having a property of separating and recovering carbon dioxide from the atmosphere.

In DAC device 11_1, for example, the air is installed in a well-ventilated region, and the atmosphere containing carbon dioxide is sucked in from an intake port provided in the front. In addition, in DAC device 11_1, carbon dioxide-recovered air is discharged from an exhaust port provided in the rear. DAC device 11_2 is installed at a stage subsequent to DAC device 11_1 (that is, in the vicinity of the exhaust port of DAC device 11_1). In DAC device 11_2, the atmosphere is sucked in from an intake port provided in the front. In addition, in DAC device 11_2, the carbon dioxide-recovered air is discharged from an exhaust port provided in the rear.

Here, in DAC system 1, it is preferable that DAC devices 11_1 and 11_2 be disposed close to each other in order to dispose as many DAC devices as possible per predetermined area to improve the carbon dioxide recovery efficiency. However, when DAC devices 11_1 and 11_2 are disposed close to each other, the carbon dioxide recovered air discharged from DAC device 11_1 is taken in by DAC device 11_2. Therefore, in DAC device 11_2, the carbon dioxide recovery process is performed on the air having a lower carbon dioxide concentration. As a consequence, there is a possibility that the carbon dioxide recovery efficiency by DAC device 11_2 is lowered.

Therefore, the DAC system 1 is provided with a stirring plate 12 between DAC device 11_1 and DAC device 11_2 for agitating the carbon dioxide-recovered air discharged from the exhaust port of DAC device 11_1 and the atmosphere. The stirring plate 12 is a plate-shaped member having a size capable of changing the direction in which air flows.

In the embodiment of FIG. 1, the stirring plate 12 is provided such that a part of the atmosphere above the air discharged from the exhaust port of DAC device 11_1 is lowered toward the air discharged from the exhaust port of DAC device 11_1. More specifically, the stirring plate 12 is located between DAC device 11_1 and DAC device 11_2 in a region where one end E1 close to DAC device 11_1 is higher than the exhaust port of DAC device 11_1. In addition, the stirring plate 12 is provided such that another end E2 close to DAC device 11_2 is located in a region lower than the one end E1. The stirring plate 12 is supported by a support rod (not shown) or the like. As a result, in the vicinity of the intake port of DAC device 11_2, the air having a low carbon dioxide concentration and the atmosphere having a high carbon dioxide concentration discharged from the exhaust port of DAC device 11_1 are agitated. Therefore, DAC device 11_2 can maintain high-efficiency carbon dioxide recovery. In addition, this enables the DAC system 1 to arrange DAC device 11_1 and DAC device 11_2 close to each other. In other words, in the DAC system 1, DAC devices 11_1 and 11_2 can be disposed close to each other while preventing the reduction in the carbon dioxide recovery rate caused by DAC devices 11_1 and 11_2.

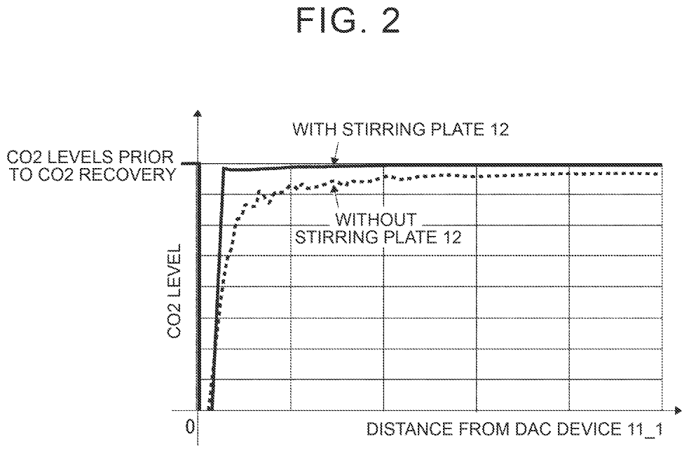

FIG. 2 is a diagram illustrating the effectiveness of DAC system-1. FIG. 2 shows the relation between the distance from the exhaust port of DAC device 11_1 and the carbon dioxide concentration in the atmosphere. As shown in FIG. 2, when the stirring plate 12 is provided, the carbon dioxide concentration in the atmosphere increases to CO concentration prior to the carbon dioxide recovery in an area closer to the exhaust port of DAC device 11_1 than when the stirring plate 12 is not provided.

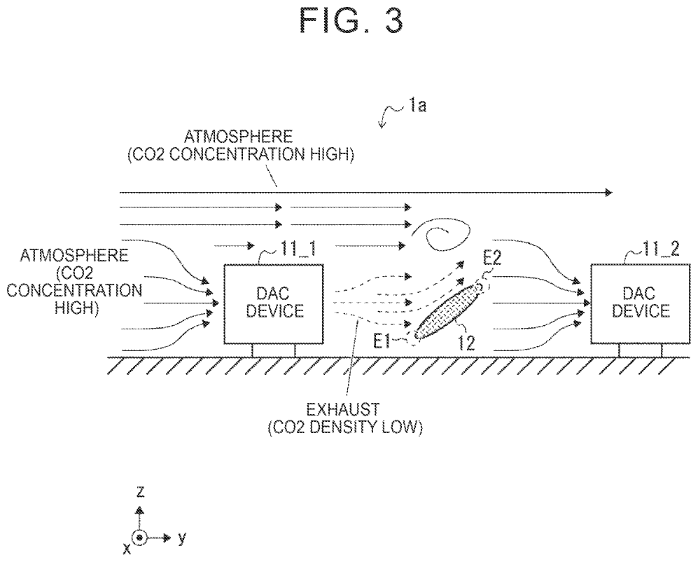

FIG. 3 is a diagram illustrating a second exemplary configuration of DAC system 1 as a 1a of a DAC system. DAC system 1a differs from DAC system 1 in the installation position of the stirring plate 12. The rest of the configuration of DAC system 1a is the same as that of DAC system 1, and therefore will not be described.

In the embodiment of FIG. 3, the stirring plate 12 is provided so that the air discharged from the exhaust port of DAC device 11_1 rises toward the atmosphere in the upper layer of the air. More specifically, the stirring plate 12 is located between DAC device 11_1 and DAC device 11_2 in a region where one end E1 close to DAC device 11_1 faces the exhaust port of DAC device 11_1. In addition, the stirring plate 12 is provided such that the another end E2 close to DAC device 11_2 is located in a region higher than the one end E1. The stirring plate 12 is supported by a support rod (not shown) or the like. As a result, in the vicinity of the intake port of DAC device 11_2, the air having a low carbon dioxide concentration and the atmosphere having a high carbon dioxide concentration discharged from the exhaust port of DAC device 11_1 are agitated. Therefore, DAC device 11_2 can maintain high-efficiency carbon dioxide recovery. In addition, this allows DAC device 11_1 and DAC device 11_2 to be arranged close to each other in the DAC system 1a. In other words, in the DAC system 1a, DAC devices 11_1 and 11_2 can be arranged close to each other while preventing the reduction in the carbon dioxide recovery rate caused by DAC devices 11_1 and 11_2.

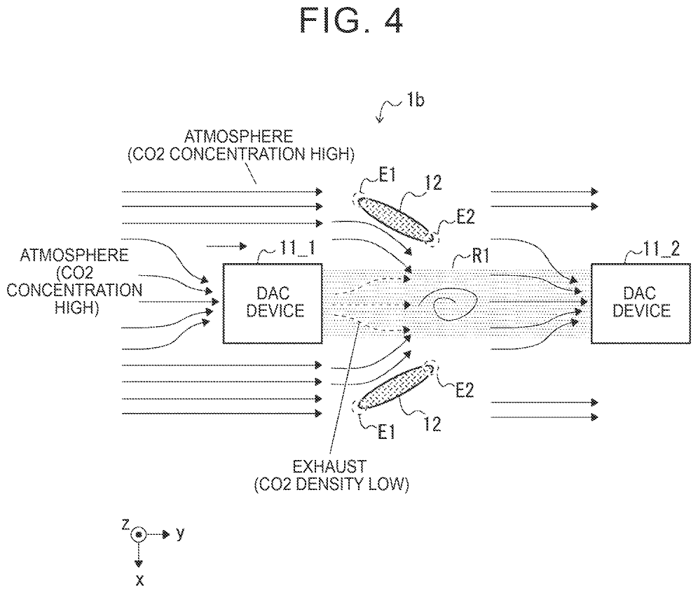

FIG. 4 is a diagram illustrating a third exemplary configuration of DAC system 1 as a DAC system 1b. DAC system 1b differs from DAC system 1 in the installation position of the stirring plate 12. The rest of the configuration of DAC system 1b is the same as that of DAC system 1, and therefore will not be described.

In the example of FIG. 4, two sets of stirring plates 12 are provided. The stirring plates 12 are positioned between DAC device 11_1 and DAC device 11_2 in a region where one end E1 close to DAC device 11_1 is outside the flow path R1 from DAC device 11_1 to DAC device 11_2 when viewed from above (viewed from the z-axis direction). The stirring plates 12 are provided such that the another end E2 closer to DAC device 11_2 is located in a region closer to the flow path R1 than the one end E1. The flow path R1 may be replaced with a line segment connecting DAC devices 11_1 and 11_2. Each stirring plate 12 is supported by a support rod (not shown) or the like. As a result, in the vicinity of the intake port of DAC device 11_2, the air having a low carbon dioxide concentration and the air having a high carbon dioxide concentration discharged from the exhaust port of DAC device 11_1 are agitated. Therefore, DAC device 11_2 can maintain high-efficiency carbon dioxide recovery. In addition, this allows DAC device 11_1 and DAC device 11_2 to be arranged close to each other in the DAC system 1b. In other words, in the DAC system 1b, DAC devices 11_1 and 11_2 can be arranged close to each other while preventing the reduction in the carbon dioxide recovery rate caused by DAC devices 11_1 and 11_2.

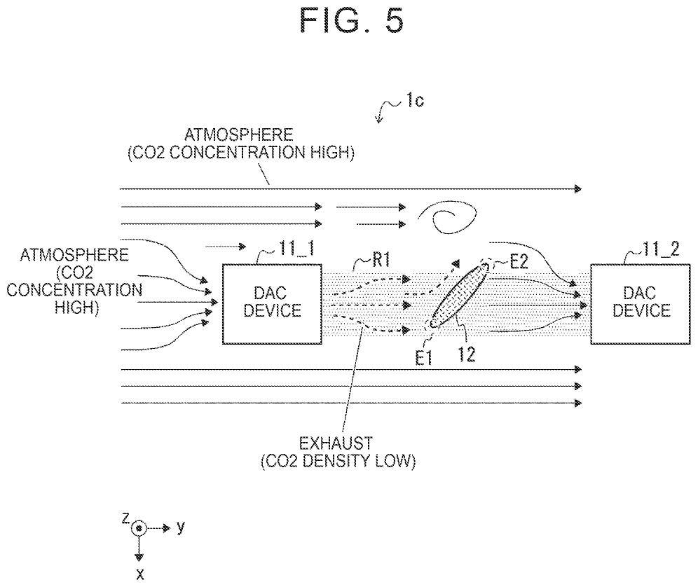

FIG. 5 is a diagram illustrating a fourth exemplary configuration of DAC system 1 as a 1c of a DAC system. DAC system 1c differs from DAC system 1 in the installation position of the stirring plate 12. The rest of the configuration of DAC system 1c is the same as that of DAC system 1, and therefore will not be described.

In the embodiment of FIG. 5, the stirring plate 12 is positioned between DAC device 11_1 and DAC device 11_2 in a top view (as viewed from the z-axis direction) in a region where one end E1 close to DAC device 11_1 faces the exhaust port of DAC device 11_1. In addition, the stirring plate 12 is provided so that the another end E2 closer to the DAC device 11_2 is located in a region deviated from the flow path R1 from the DAC device 11_1 to the DAC device 11_2. The stirring plate 12 is supported by a support rod (not shown) or the like. As a result, in the vicinity of the intake port of DAC device 11_2, the air having a low carbon dioxide concentration and the air having a high carbon dioxide concentration discharged from the exhaust port of DAC device 11_1 are agitated. Therefore, DAC device 11_2 can maintain high-efficiency carbon dioxide recovery. In addition, this allows DAC device 11_1 and DAC device 11_2 to be arranged close to each other in DAC system 1c. In other words, in the DAC system 1c, DAC devices 11_1 and 11_2 can be arranged close to each other while preventing the reduction in the carbon dioxide recovery rate caused by DAC devices 11_1 and 11_2.

As described above, in DAC system 1 according to the present embodiment, the carbon dioxide recovered air discharged from the exhaust port of DAC device 11_1 and the atmosphere are agitated by using the stirring plate 12. By this stirring, it is possible to prevent a reduction in the efficient recovery of carbon dioxide by DAC device 11_2 adjoining DAC device 11_1. Consequently, DAC device 11_1 and DAC device 11_2 can be arranged close to each other. In other words, in DAC system 1 according to the present embodiment, DAC devices 11_1 and 11_2 can be disposed close to each other while preventing the reduction in the carbon dioxide recovery rate caused by each of DAC devices 11_1 and 11_2.

In the present embodiment, the DAC system 1 includes two DAC devices 11_1 to 11_2 and one or a pair of stirring plates 12. However, the embodiment is not limited thereto. DAC system 1 may further include a DAC device 11_3 at a subsequent stage of DAC device 11_2 (that is, in the vicinity of the exhaust port of DAC device 11_2). DAC system 1 may further include a stirring plate 13 similar to the stirring plate 12 between DAC device 11_2 and DAC device 11_3.

Further, DAC system 1 may include a plurality of DAC devices 11_1 arranged in the lateral direction (x-axis direction), a plurality of DAC devices 11_2 arranged in the lateral direction in a subsequent stage of each of the plurality of DAC devices 11_1 (i.e., in the vicinity of the exhaust port of each of the plurality of DAC devices 11_1), and a plurality or a plurality of sets of stirring plates 12 respectively provided between the plurality of DAC devices 11_1 and the plurality of DAC devices 11_2. Further, DAC system 1 may further include a plurality of DAC devices 11_3 arranged laterally at a subsequent stage of each of the plurality of DAC devices 11_2 (i.e., in the vicinity of the exhaust port of each of the plurality of DAC devices 11_2), and a plurality or a plurality of sets of stirring plates 13 respectively provided between the plurality of DAC devices 11_2 and the plurality of DAC devices 11_3.

The present disclosure is not limited to the above-described embodiments, and can be appropriately modified without departing from the spirit thereof. The present disclosure contributes to carbon neutral, decarbonization, and Sustainable Development Goals (SDGs).

What is claimed is:

1. A direct air capture system comprising:
a first direct air capture device that recovers carbon dioxide from an atmosphere;
a second direct air capture device in which an intake port is installed to be located at a side of an exhaust port of the first direct air capture device, and that recovers carbon dioxide from an atmosphere; and
a stirring plate installed between the first direct air capture device and the second direct air capture device and configured to stir air discharged from the exhaust port of the first direct air capture device and an atmosphere.

2. The direct air capture system according to claim 1, wherein the stirring plate is provided in such a manner that one end closer to the first direct air capture device is located in a region higher than the exhaust port of the first direct air capture device, and another end is located in a region lower than the one end such that a part of an atmosphere in an upper layer than the air discharged from the exhaust port of the first direct air capture device falls toward the air discharged from the exhaust port of the first direct air capture device.

3. The direct air capture system according to claim 1, wherein the stirring plate is provided in such a manner that one end closer to the first direct air capture device is located in a region facing the exhaust port of the first direct air capture device, and another end is located in a region higher than the one end such that the air discharged from the exhaust port of the first direct air capture device rises toward an atmosphere in an upper layer than the air.

4. The direct air capture system according to claim 1, wherein the stirring plate is provided such that, when seen from a top view, one end closer to the first direct air capture device is located in a region deviated from a flow path from the first direct air capture device to the second direct air capture device, and another end is located in a region closer to the flow path than the one end is.

5. The direct air capture system according to claim 1, wherein the stirring plate is provided such that, when seen from a top view, one end closer to the first direct air capture device is located in a region facing the exhaust port of the first direct air capture device, and another end is located in a region deviated from a flow path from the first direct air capture device to the second direct air capture device.
